(19) United States
(12) Patent Application Publication
(10) Pub. No.: US 2006/0285151 A1
(43) Pub. Date: Dec. 21, 2006

(54) Image forming system and conversion module device

(75) Inventor: Hiroshi Kurita, Ebina-shi (JP)

Correspondence Address: MORGAN LEWIS & BOCKIUS LLP, 1111 PENNSYLVANIA AVENUE NW, WASHINGTON, DC, 20004, US

(73) Assignee: FUJI XEROX CO., LTD.

(21) Appl. No.: 11/265,149

(22) Filed: Nov. 3, 2005

(30) Foreign Application Priority Data
Jun. 20, 2005 (JP) 2005-179788

(51) Int. Cl. G06F 3/12

(52) U.S. Cl. 358/1.15; 358/1.13

(57) ABSTRACT

An image forming system comprises an image forming device to form an image on a recording medium; a peripheral device that transmits and receives data in a data communication system, the data communication system of the peripheral device is different from a data communication system of the image forming device; and a conversion module device that receives a request transmitted from the image forming device to the peripheral device in a specified data communication system, and creates a response to the request in accordance with the specified data communication system of the image forming device, and transmits the response to the image forming device, the convention module device connected to the image forming device and the peripheral device.

### BACKGROUND OF THE INVENTION

(1) Field of the Invention

The present invention relates to a technique to perform a processing in an image forming system including plural devices.

(2) Description of the Related Art

A processing performed after an image is formed on a recording sheet by an image forming device such as a printer or a copying machine is generically called a “post-processing”. The specific content of the processing is such a specified processing that the recording sheet is fastened with a staple, the recording sheet is discharged to a specified paper output tray among plural paper output trays, or a discharge position in a paper output tray is offset. The user can specify the kinds of these post-processings in image formation job units. For example, a related art proposes an image forming system in which an image forming device and a post-processing device are connected through a communication unit, and data are mutually exchanged, so that various post-processings can be performed. Besides, another related art proposes a technique to judge a connection state of an image forming device main body and various post-processing devices. According to this technique, it is possible to judge how many post-processing devices are connected in what order when viewed from the image forming device.

As a data communication system between an image forming device and a post-processing device, although a parallel communication system was common in the past, thereafter, it shifted to a serial communication system, and more recently, it has been changed to a multi-node serial communication called CAN (Controller Area Network) in which high speed communication can be performed among plural devices. From the circumstances as stated above, although there are image forming devices of various data communication systems and post-processing devices, since there is no mutual communication compatibility, there has been a problem that only a specific post-processing device can be connected to a specific image forming device.

### SUMMARY OF THE INVENTION

The present invention has been made in view of the above circumstances and provides an image forming.

According to an aspect of the invention, an image forming system comprises an image forming device to form an image on a recording medium; a peripheral device that transmits and receives data in a data communication system, the data communication system of the peripheral device is different from a data communication system of the image forming device; and a conversion module device that receives a request transmitted from the image forming device to the peripheral device in a specified data communication system, and creates a response to the request in accordance with the specified data communication system of the image forming device, and transmits the response to the image forming device, the convention module device connected to the image forming device and the peripheral device.

### BRIEF DESCRIPTION OF THE DRAWINGS

Embodiments of the invention will be described in detail based on the following figures, wherein:

FIG. 1 is a view showing a structure of an image forming system according to an embodiment of the invention;

FIG. 2 is a schematic view showing an outer appearance structure of each device (IOT, HCF, HCS, DFA) of a portion surrounded by a dotted line in the image forming system;

FIG. 3 is a view showing an inner structure of the IOT, HCF, HCS and DFA;

FIGS. 4A to 4E are views showing outer appearance structures of other image forming systems;

FIGS. 5A to 5C are block diagrams showing connection modes of the IOT and the HCS or DFA;

FIG. 6 is a circuit structural view of an FIU;

FIG. 7 is a sequence view showing a processing procedure among the IOT, HCF, HCS and DFA;

FIGS. 8A and 8B are views showing display examples of screens displayed on the IOT;

FIG. 9 is a view showing a display example of a screen displayed on the IOT; and

FIG. 10 is a view for explaining a transport schedule of a recording sheet.

### DETAILED DESCRIPTION OF THE INVENTION

An embodiment for carrying out the invention will be described.

(1) Structure

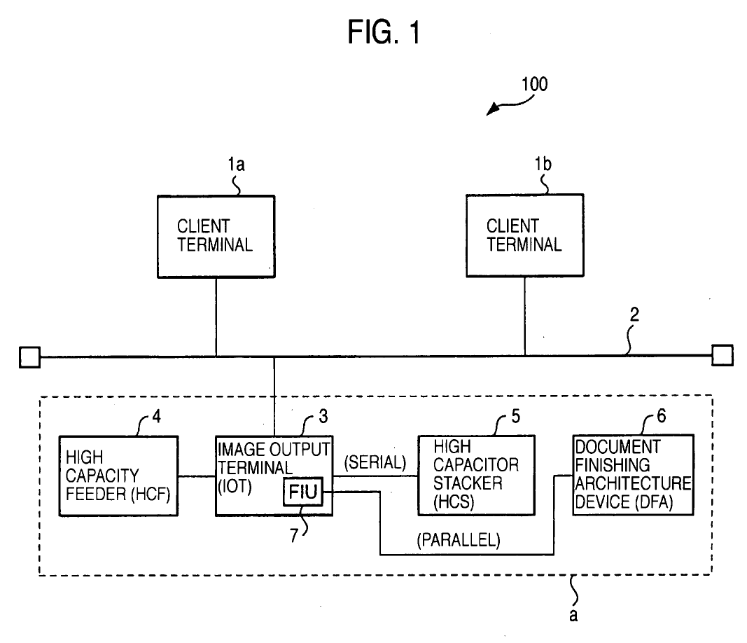

FIG. 1 is a view showing a structural example of an image forming system 100 in this embodiment. As shown in FIG. 1, in this image forming system 100, plural client terminals 1a and 1b, such as personal computers, are connected to an image forming device (Image Output Terminal: hereinafter simply referred to as IOT) 3 through a network 2. Further, the IOT 3 is connected with a feeder (High Capacity Feeder: hereinafter simply referred to as HCF) 4, a first post-processing device (High Capacity Stacker: hereinafter simply referred to as HCS) 5, and a second post-processing device (Document Finishing Architecture Device: hereinafter simply referred to as DFA) 6. The HCS 5 is a peripheral device to perform data communication in a serial communication system (for example, RS422/RS488/CAN, etc.), whereas the DFA 6 is a peripheral device to perform data communication in a parallel communication system. Incidentally, although not shown in FIG. 1, an image input device (Image Input Terminal: hereinafter simply referred to as IIT) such as a scanner may be connected to the IOT 3.

The IOT 3 is, for example, a printer of an electrophotographic system or a copying machine, and forms an image on a recording sheet based on image data received from the client terminal 1a, 1b through the network 2, or forms an image on a recording sheet based on image data read out by the IIT. This IOT 3 includes a conversion module device (Finishing Interface Unit: hereinafter simply referred to as FIU) 7 to perform, instead of the DFA 6, data communication with a controller of the IOT 3. The FIU 7 may be incorporated in the IOT 3 or may be a device separate from the IOT 3. The HCF 4 stores a large number of recording sheets and supplies these one by one to the IOT 3. The HCF 4 is connected to the upstream side in the transport direction of the recording sheet when viewed from the IOT 3. The HCS 5 is connected to the downstream side of the IOT 3 and stores a large number of recording sheets on which images have been formed by the IOT 3. The DFA 6 is similarly connected to the downstream side of the IOT 3, and performs, to the recording sheet on which the image has been formed by the IOT 3, a staple processing, a recording sheet cut processing or a folding processing, and stores it.

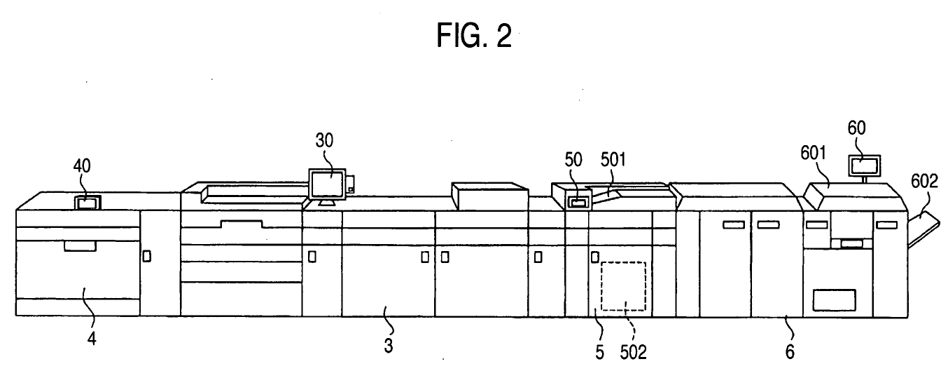

Next, FIG. 2 is a view showing an outer appearance structure of a device group (IOT 3, HCF 4, HCS 5, DFA 6) surrounded by a dotted line “a” of FIG. 1. As shown in FIG. 2, the IOT 3 includes a user interface part 30 constructed as a touch panel by which the user performs various operations and settings. Similarly, the HCF 4, the HCS 5, and the DFA 6 also include user interface parts 40, 50 and 60 constructed as touch panels. The HCS 5 includes a paper output tray 501 (hereinafter referred to as a top tray 501) provided at the upper part of a housing and a large capacity paper output tray 502 (hereinafter referred to as a stack tray 502) contained in the inside of the housing, and further includes a mechanism (not shown) for offsetting and discharging the recording sheets to the paper output trays, and a bypass discharge passage (not shown) for directly discharging the recording sheet to the outside (here, the DFA 6) of the housing. The DFA 6 includes a paper output tray 601 (hereinafter referred to as a top tray 601) provided at the upper part of the housing and a paper output tray 602 (hereinafter referred to as a stack tray 602) provided at the side of the housing, and further includes a mechanism (not shown) for offsetting and discharging the recording sheets to the paper output trays, and a stapler device (not shown) for fastening the recording sheets with a staple.

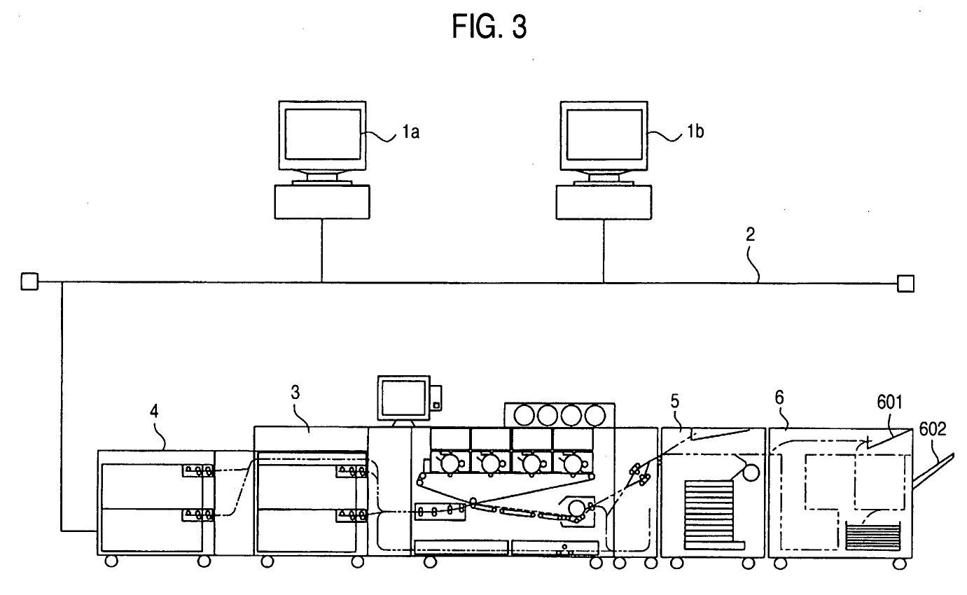

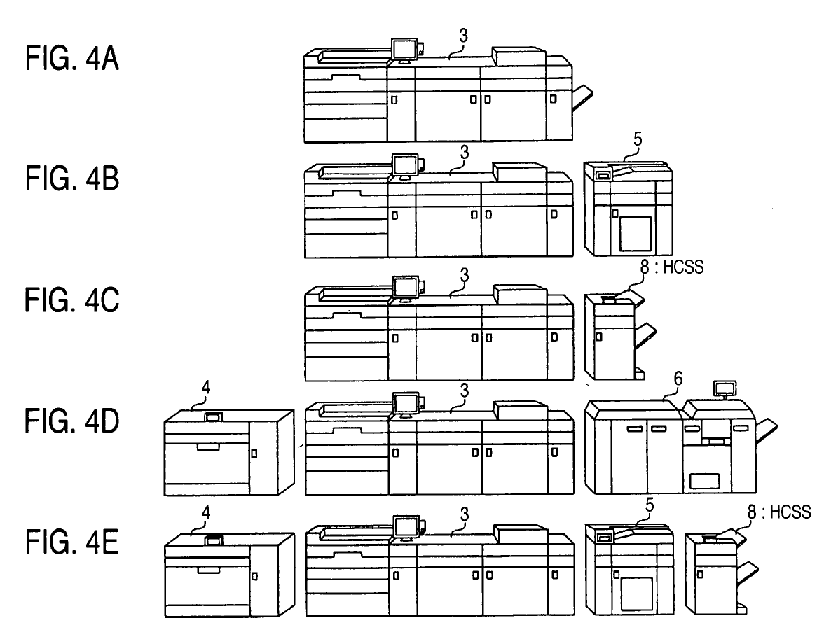

Here, FIG. 3 is a view showing an inner structure of the device group shown in FIG. 2. An alternate long and short dash line in FIG. 3 indicates a transport passage of the recording sheet. Incidentally, although FIG. 3 shows the case where the HCF 4 is connected to the upstream side of the IOT 3, and the HCS 5 and the DFA 6 are connected to the downstream side, in addition to this, there are various connection modes as shown in FIGS. 4A to 4E. FIG. 4A shows a state where no additional device, such as a sheet feeder or a post-processing device, is not connected to the IOT 3. FIG. 4B shows a state where the HCS 5 is connected to the downstream side of the IOT 3. FIG. 4C shows a state where a post-processing device 8 (High Capacity Staple Stacker; hereinafter simply referred to as HCSS), which is a serial device to perform data communication in the serial communication system, is connected to the downstream side of the IOT 3. FIG. 4D shows a state where the HCF 4 is connected to the upstream side of the IOT 3, and the DFA 6 is connected to the downstream side. FIG. 4E shows a state where the HCF 4 is connected to the upstream side of the IOT 3, and the HCS 5 and the HCSS 8 are connected to the downstream side.

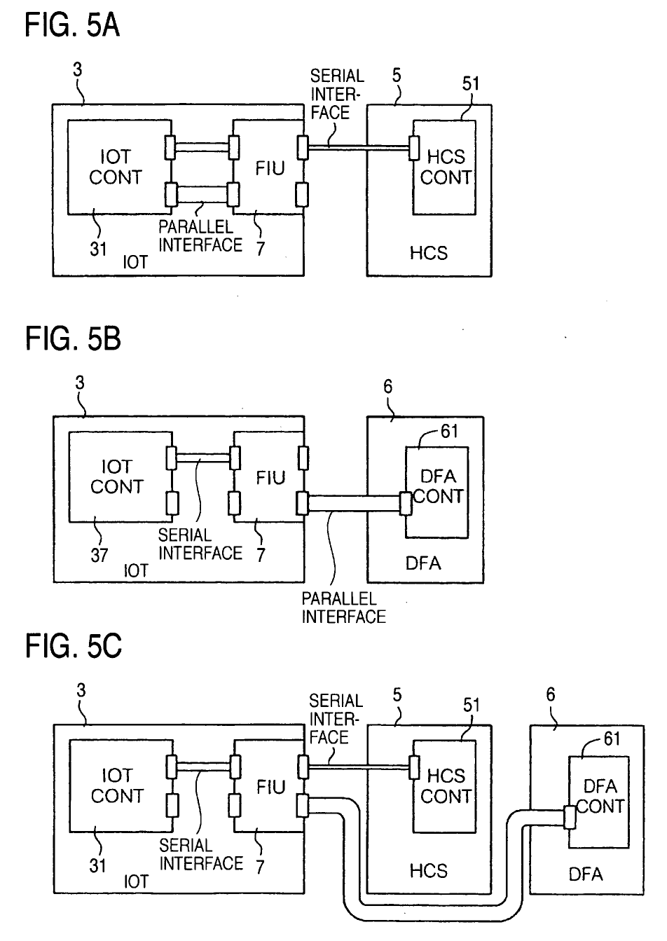

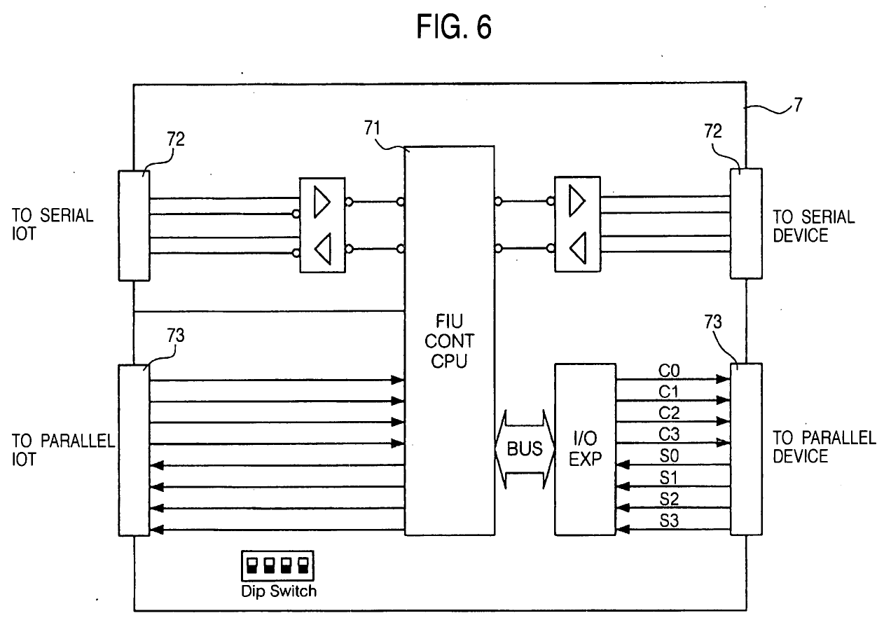

Next, FIGS. 5A to 5C are views showing connection modes between the IOT 3 and a post-processing device. FIG. 5A shows a state where the HCS 5 is connected to the IOT 3. In this case, the FIU 7 of the IOT 3 and a controller 51 of the HCS 5 are connected through a serial interface. Besides, FIG. 5B shows a state where the DFA 6 is connected to the IOT 3. In this case, the FIU 7 and a controller 61 of the DFA 6 are connected through a parallel interface. FIG. 5C shows a state where the HCS 5 and the DFA 6 are connected to the IOT 3. In this case, the FIU 7 and the controller 51 of the HCS 5 are connected through the serial interface, and the FIU 7 and the controller 61 of the DFA 6 are connected through the parallel interface. FIG. 6 is a circuit structural view of the FIU 7. As shown in the drawing, a serial interface 72 and a parallel interface 73 are respectively connected to a controller 71 which controls the FIU 7.

When receiving a request command transmitted from the IOT 3 to the DFA 6 in the serial communication system, the controller 71 of the FIU 7 creates a response command to the request command in accordance with the serial communication system and transmits it to the IOT 3, so that the IOT 3 and the post-processing device different from each other in the data communication system can be seemingly communication connected. Specifically, when detecting that the DFA 6 as a device of the parallel communication system is connected, the controller 71 of the FIU 7 seemingly creates connection information to indicate the state where the DFA 6 is connected as if the device of the serial communication system is connected to the IOT 3, and device information of the DFA 6 including a device ID, a processing capability and the like, and transmits it as data of the serial communication system to the controller 31 of the IOT 3. By this, the IOT 3 can control the post-processing device irrespective of the data communication system of the connected post-processing device. Besides, the controller 31 of the IOT stores information (in this embodiment, the information is regarded as the information indicating the constraint of the post-processing and is referred to as “constraint conditions”) to indicate what kind of post-processing can be performed by the post-processing device or what kind of post-processing can not be performed. When a constraint condition to be used among the constraint conditions is selected by an upper rank module device (for example, the client terminal 1a, 1b) connected to the IOT 3, the controller 31 compares the content of the job with the selected constraint condition at the time of start of the job, and as a result of the comparison, in the case where the job can not be performed, a setting operation of the job in the IOT 3 or an image formation operation is inhibited. By this, the detailed constraint conditions of the DFA 6 connected in the parallel communication system can be set, and it may become possible to accurately control the DFA 6.

(2) Operation

Next, an operation of this embodiment will be described.

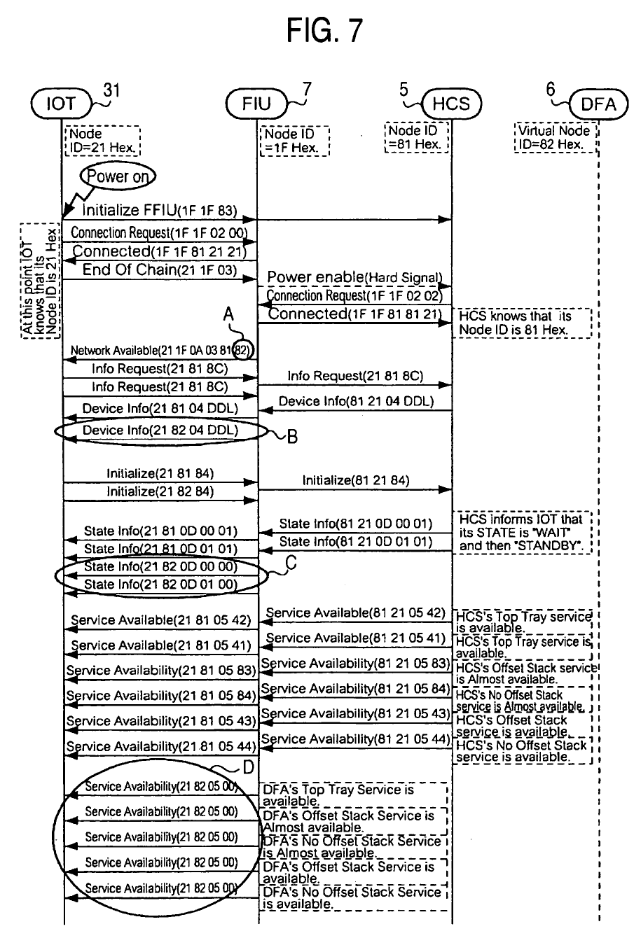

FIG. 7 is a sequence view showing a processing procedure performed among the IOT 3 (controller 31), the FIU 7, the HCS 5 and the DFA 6. In FIG. 7, in the IOT 3, when power-on is instructed by the user, the IOT 3 (controller 31) first sends an initialize command for instructing initialization to the FIU 7. Next, the IOT 3 (controller 31) sends a Connection Request command for making a connection request to the FIU 7. In response to this, the FIU 7 sends a Connected command for notifying that the connection is made to the IOT 3 (controller 31). The IOT 3 (controller 31) sends an End Of Chain command to the FIU 7.

Next, the FIU 7 causes a Power enable line, which is a signal line of hardware to instruct the HCS 5 connected to the downstream side to turn on the power, to be put into an active state. The HCS 5 having received this signal sends a Connection Request command for making a connection request to the FIU 7. In response to this, the FIU 7 sends a Connected message for notifying that the connection has been made to the HCS 5. This command includes device ID=81 assigned to the HCS 5 by the FIU 7, and by this, the HCS 5 can know its own device ID.

Next, when detecting that the peripheral device (DFA 6) of a data communication system different from the data communication system of the IOT 3 is connected, the FIU 7 assigns device ID=82 to the DFA 6. The FIU 7 sends a Network Available message to the IOT 3 (controller 31). This Network Available message includes the device ID=81 assigned to the HCS 5 by the FIU 7 and the device ID=82 (portion surrounded by a solid line A in the drawing) assigned to the DFA 6 by the FIU 7. In response to this, the IOT 3 sends an Information Request command for requesting information relating to the respective post-processing devices of the device ID=81, 82. The FIU 7 transfers the Information Request command for requesting the information of the post-processing device (the HCS 5) of the device ID=81 to the HCS 5, and when receiving Device Information including the device information from the HCS 5, the FIU 7 sends it to the IOT 3.

On the other hand, when receiving the Information Request command for requesting the information of the post-processing device (the DFA 6) of the device ID=82, the FIU 7 sends Device Information (portion surrounded by a solid line B in the drawing) including the device information of the DFA 6 stored in itself to the IOT 3. When receiving the Device Information, the IOT 3 sends an initialize command for instructing initialization to the HCS 5. When receiving the initialize command, the HCS 5 sends State Information (here, message meaning that initialization is started) for notifying the state of its own device to the IOT 3. When receiving this, the FIU 7 transfers it to the IOT 3. Further, instead of the DFA 6, the FIU 7 sends State Information (portion surrounded by a solid line C in the drawing) meaning that the DFA 6 is initialized to the IOT 3.

Next, the HCS 5 sends Service Availability for notifying constraint conditions as to what post-processing can be performed to the IOT 3 (controller 31) via the FIU 7. For example, the content of Service Availability sent from the HCS 5 is information as to whether a service (function) which can be provided by the DFA 6, such as a top tray discharge function, stack tray discharge function, bypass discharge function or offset discharge function, can be used or not. Besides, the content of Service Availability sent from the DFA 6 is information as to whether a service (function), such as a trim (cut) function, striping function, front stable function, rear staple function, dual staple function, folding function, sample tray discharge function, stack tray discharge function, or offset discharge function, can be used or not.

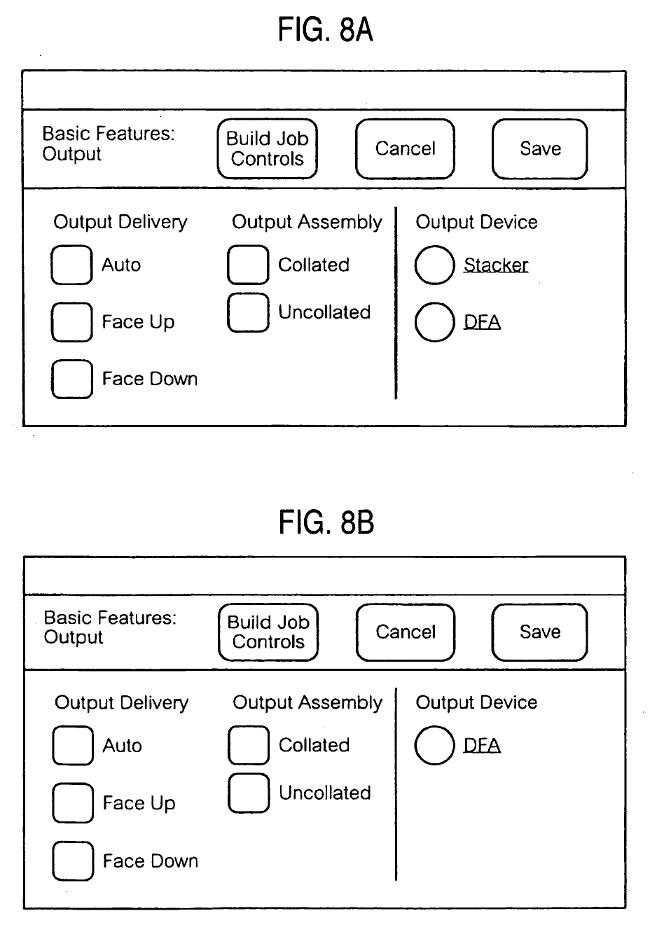

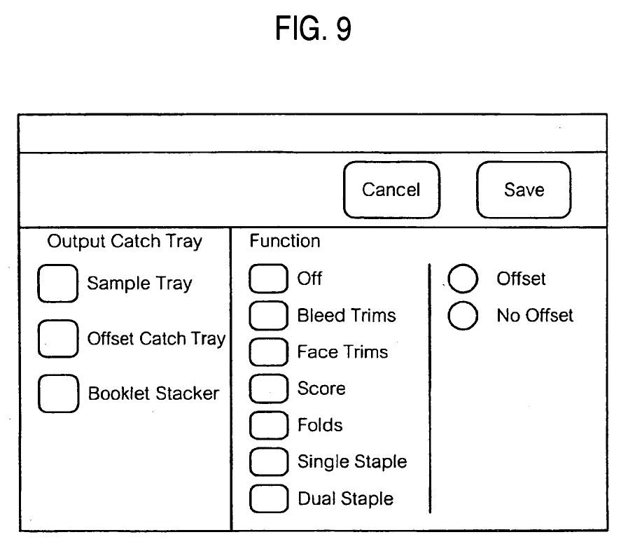

Besides, the FIU 7 previously stores the constraint conditions as to what post-processing can be performed by the DFA 6, and sends Service Availability (portion surrounded by a solid line D in the drawing) for notifying these constraint conditions to the IOT 3 (controller 31). The IOT 3 displays job setting screens as shown in FIGS. 8A and 8B and FIG. 9 on the user interface part 30 based on the received information. FIG. 8A shows an example of a screen in the case where the HCS 5 and the DFA 6 are connected to the downstream side of the IOT 3, and FIG. 8B shows an example of a screen in the case where only the DFA 6 is connected to the downstream side of the IOT 3. FIG. 9 is a view showing a display example of a screen displayed on the user interface part 30 in the case where a button icon of “DFA” displayed on the screen shown in FIGS. 8A and 8B is selected and depressed. While referring to the screen as stated above, the user can specify the kind of the post-processing as to each image formation job. The kind of the specified post-processing is stored in a memory of the controller 31 of the IOT 3, and the job is performed based on the storage content. At this time, the controller 31 of the IOT compares the content of the specified job with the specified constraint condition, and as a result of the comparison, in the case where the job can not be performed, the setting operation of the job in the IOT 3 as in FIGS. 8A and 8B and FIG. 9 or the image formation operation itself maybe inhibited.

According to the embodiment described above, the FIU 7 creates the connection information relating to the state where the post-processing device is connected or the device information relating to the processing capability of the peripheral device in accordance with the data communication system (serial communication system) of the IOT 3, and transmits the created connection information or device information to the controller 31 of the IOT 3. By this, it becomes possible to perform the processing even if the data communication system is different between the IOT 3 and the DFA 6. Besides, since the detailed constraint conditions of the DFA 6 connected in the parallel communication system can be set, it may become possible to accurately control the DFA 6.

(3) Modified Example

The foregoing embodiment can be modified as described below.

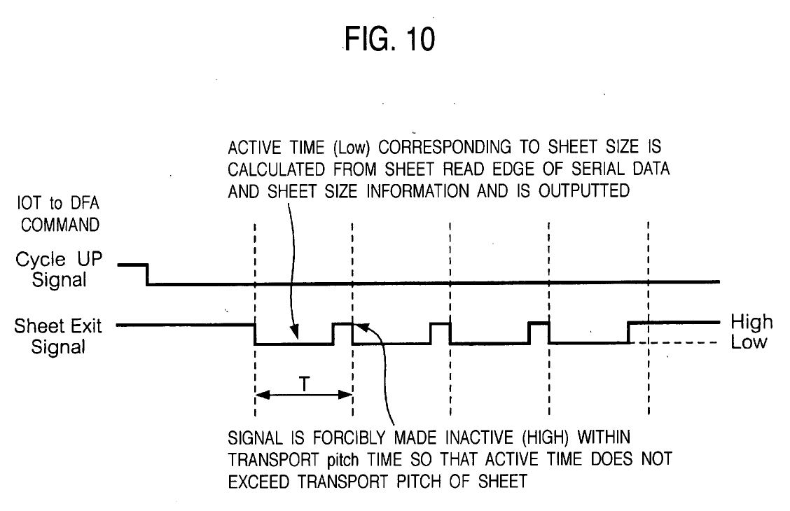

In the case where the size of a recording sheet varies in one job, there is a following problem. In FIG. 10, a time T denotes a transport pitch of a recording sheet. When a job is performed in such a transport pitch, in the case where there is an image formation process to a recording sheet of a larger size, there is a case where an active time when Sheet Exit Signal is low (Low) exceeds the transport pitch T, and this is inconvenient. Then, the controller 31 of the IOT 3 stores a transport pitch for each size of a recording medium in a post-processing device to perform data communication in the parallel communication system, and may perform a signal control relating to the transport of a recording medium. Specifically, the controller 31 calculates, from the length of a recording medium, an active time of a signal when data pursuant to the serial communication system is converted into data pursuant to the parallel communication system, and performs a control to forcibly make the signal inactive (High state) so as not to exceed the transport pitch of the recording medium.

Besides, in the embodiment, although the description has been made while the recording sheet is named as an example of the recording medium on which an image is formed, in addition to this, various recording mediums such as plastic, for example, an OHP film, and a cloth can be used. Incidentally, a program executed by the controller 32 described in the embodiment can be provided in a state where it is recorded on a recording medium such as a magnetic tape, magnetic disk, floppy (registered trademark) disk, optical recording medium, magneto-optical recording medium, CD (Compact Disk)-ROM, DVD (Digital Versatile Disk) or RAM.

As described above, some embodiments of the invention are outlined below.

According to an aspect of the invention, the image forming system includes an image forming device to form an image on a recording medium, a peripheral device to transmit/receive data in a data communication system different from the image forming device, and a conversion module device that is connected to the image forming device and the peripheral device, creates, when receiving a request transmitted from the image forming device to the peripheral device in a specified data communication system, a response to the request in accordance with the specified data communication system of the image forming device, and transmits it to the image forming device.

In the image forming system, the image forming device may perform communication in a serial communication system, and the peripheral device may perform communication in a parallel communication system.

The peripheral device may be a post-processing device to perform a specified processing to a recording sheet after an image is formed.

Besides, in the image forming system, the conversion module device may include a detection unit to detect that the peripheral device of the data communication system different from the specified data communication system of the image forming device is connected, a creation unit to create, in accordance with the specified data communication system of the image forming device, connection information to indicate a state where the peripheral device is connected or device information to indicate processing capability of the peripheral device, and a transmission unit to transmit the created connection information or device information to the image forming device.

Besides, the image forming device may include a constraint condition memory to store constraint conditions indicating constrains of processing of plural peripheral devices to perform data communication in the parallel communication system, and an inhibition unit that compares, when a constraint condition to be used in a job is selected by an upper rank module device connected to the image forming device, content of the job with the selected constraint condition at a start of the job, and inhibits, in a case where as a result of the comparison, the job can not be performed, a setting operation of the job in the image forming device or an image formation operation.

Besides, the image forming device may include a required time memory to store a time required to change a discharge destination of the recording medium or content of a post-processing in a post-processing device to perform data communication in a parallel communication system, and a controller that controls, in a case where the discharge destination of the recording medium or the content of the post-processing is changed, transport of the recording medium to lengthen a discharge interval of the recording medium by the time stored in the required time memory.

The controller may calculate, from a length of the recording medium, an active time of a signal when data pursuant to a serial communication system is converted into data pursuant to the parallel communication system, and may perform the transport control to lengthen the discharge interval of the recording medium by a transport pitch of the recording medium.

According to another aspect of the invention, a conversion module device includes a detection unit to detect that a peripheral device of a data communication system different from a data communication system of an image forming device is connected, a creation unit to create, in accordance with the data communication system of the image forming device, connection information as to a state where the peripheral device is connected or device information as to an attribute of the peripheral device itself, and a transmission unit to transmit the created connection information or device information to the image forming device.

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

The entire disclosure of Japanese Patent Application No. 2005-179788 filed on Jun. 20, 2005 including specification, claims, drawings and abstract is incorporated herein by reference in its entirety.

What is claimed is:

1. An image forming system comprising:
an image forming device to form an image on a recording medium;
a peripheral device that transmits and receives data in a data communication system, the data communication system of the peripheral device is different from a data communication system of the image forming device; and
a conversion module device that receives a request transmitted from the image forming device to the peripheral device in a specified data communication system, and creates a response to the request in accordance with the specified data communication system of the image forming device, and transmits the response to the image forming device, the convention module device connected to the image forming device and the peripheral device.

2. The image forming system according to claim 1, wherein the image forming device performs communication in a serial communication system, and the peripheral device performs communication in a parallel communication system.

3. The image forming system according to claim 1, wherein the peripheral device is a post-processing device to perform a specified processing to a recording medium after the image is formed.

4. The image forming system according to claim 1, wherein the conversion module device includes:
a detection unit that detects that the peripheral device having the data communication system different from the specified data communication system of the image forming device is connected;
a creation unit that creates, connection information to indicate a state where the peripheral device is connected or device information to indicate processing capability of the peripheral device in accordance with the specified data communication system of the image forming device; and
a transmission unit that transmits the created connection information or the created device information to the image forming device.

5. The image forming system according to claim 2, wherein the image forming device includes:
a constraint condition memory that stores constraint conditions indicating constrains of processing of a plurality of peripheral devices to perform data communication in the parallel communication system; and
an upper rank module device connected to the image forming device that selects a constraint condition to be used in a job,
an inhibition unit that compares content of the job with the selected constraint condition at a start of the job, and inhibits a setting operation of the job in the image forming device or an image formation operation in a case where as a result of the comparison, the job can not be performed.

6. The image forming system according to claim 1, wherein the image forming device includes:
a required time memory that stores a time required to change a discharge destination of the recording medium or content of a post-processing in a post-processing device to perform data communication in a parallel communication system; and
a controller that controls transport of the recording medium to lengthen a discharge interval of the recording medium by the time stored in the required time memory in a case where the discharge destination of the recording medium or the content of the post-processing is changed.

7. The image forming system according to claim 6, wherein the controller calculates an active time of a signal when data pursuant to a serial communication system is converted into data pursuant to the parallel communication system from a length of the recording medium, and performs the control to lengthen the discharge interval of the recording medium by a transport pitch of the recording medium.

8. A conversion module device comprising:
a detection unit that detects a peripheral device having a data communication system different from a specified data communication system of an image forming device is connected;
a creation unit that creates connection information indicating a state where the peripheral device is connected or device information indicating processing capability of the peripheral device in accordance with the specified data communication system of the image forming device; and
a transmission unit that transmits the created connection information or the created device information to the image forming device.
